(19) United States
(12) Patent Application Publication
(10) Pub. No.: US 2019/0170407 A1
(43) Pub. Date: Jun. 6, 2019

(54) MAGNETIC COOLING SYSTEMS

(71) Applicant: General Electric Company, Schenectady, NY (US)

(72) Inventors: Jalal Hunain Zia, Niskayuna, NY (US); Francis Johnson, Clifton Park, NY (US); Marco Santini, Florence (IT); Vijay Kumar Srivastava, Niskayuna, NY (US); Kimberly Nicole Hammer, Niskayuna, NY (US)

(21) Appl. No.: 15/830,182

(22) Filed: Dec. 4, 2017

(51) Int. Cl. F25B 21/00; F02C 7/143

(52) U.S. Cl. CPC F25B 21/00; F25B 2321/0022; F02C 7/143

(57) ABSTRACT

A magnetic cooling system is presented. The system includes at least one magnetic assembly, at least one magnetic regenerator including a magnetocaloric material, movably arranged in a closed loop to cyclically pass through the at least one magnetic assembly and a fluid supply device in fluid communication with the at least one magnetic assembly to supply a cooling fluid to the at least one magnetic assembly. A turbine assembly including a magnetic cooling system disposed in a path of an inlet air to a turbine system is also presented.

Embodiments of the present disclosure generally relate to magnetic cooling systems such as magnetocaloric refrigeration systems for cooling. More particularly, embodiments of the present disclosure relate to magnetocaloric refrigeration systems for cooling gas turbine inlet air.

### BACKGROUND

A gas turbine engine combusts a mixture of fuel and air to drive one or more turbine stages. The gas turbine engine generally intakes ambient air into a compressor, which compresses the air to a suitable pressure for optimal combustion of the fuel in a combustor. Unfortunately, the temperature and humidity of the ambient air can vary significantly due to geographic location, seasons, and so forth. A temperature variation of the ambient air may lead to reduced performance of the gas turbine engine. For example, an increase of 50 degrees in temperature may causes more than 25 percent loss of power.

One approach for avoiding the power degradation caused by high temperature of the ambient air is cooling the inlet air before compressing it in the compressor. Such inlet air cooling causes the air to have a higher density so as to create a higher mass flow rate into the compressor. The higher mass flow rate of the air in a compressor allows more air to be compressed so as to allow the gas turbine engine to produce more power output.

Various refrigeration techniques have been proposed such as vapor compression refrigeration, absorption cooling, and evaporative cooling. Disadvantages of such techniques are high cost and energy consumption, utilization of environmentally hazardous fluids (for example, HCFCs) and unreliability of the cooling capacity due to the dependency upon vagaries of weather.

Magnetic refrigeration uses a magnetocaloric material to provide cooling in some refrigeration systems. However, the amount of cooling from conventional magnetic refrigeration systems may not be sufficient for the cooling of inlet air of the gas turbine engines.

### BRIEF DESCRIPTION

An improved magnetic cooling system suitable for cooling of inlet air of gas turbine engines, for example, is disclosed herein. In one aspect, the magnetic cooling system includes at least one magnetic assembly, at least one magnetic regenerator including a magnetocaloric material movably arranged in a closed loop to cyclically pass through the at least one magnetic assembly and a fluid supply device in fluid communication with the at least one magnetic assembly to supply a cooling fluid to the at least one magnetic assembly.

In another aspect, a turbine assembly includes a magnetic cooling system disposed in a path of an inlet air to a turbine system.

### BRIEF DESCRIPTION OF DRAWINGS

These and other features and aspects of embodiments of the present disclosure will become better understood when the following detailed description is read with reference to the accompanying drawings in which like characters in each individual figure, represent like parts throughout the drawings, wherein:

FIG. 1 is a block diagram of a magnetic cooling system, in accordance with some embodiments of the present disclosure.

FIG. 2 is a schematic of a magnetic cooling system, in accordance with some embodiments of the present disclosure.

FIG. 3 is a block diagram of a magnetic cooling system, in accordance with some other embodiments of the present disclosure.

FIG. 4 is a block diagram of a magnetic cooling system, in accordance with yet some other embodiments of the present disclosure.

FIG. 5 is a schematic of a magnetic cooling system, in accordance with some embodiments of the present disclosure.

FIG. 6 is a schematic of a turbine assembly including a magnetic cooling system, in accordance with some embodiments of the present disclosure.

### DESCRIPTION

Provided herein are magnetic cooling systems. In particular, embodiments of the present disclosure provide magnetic cooling systems employing magnetocaloric materials. The magnetic cooling systems provides improved cooling, and can be used for various applications such as, for example, cooling inlet air of gas turbines, cooling homes, and cooling offices.

In the following specification and the claims, singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

Approximating language, as used herein throughout the specification and claims, may be applied to modify any quantitative representation that could permissibly vary without resulting in a change in the basic function to which it is related. Accordingly, a value modified by a term such as “about” or “substantially” is not limited to the precise value specified.

In some embodiments, a magnetic cooling system includes at least one magnetic assembly, at least one magnetic regenerator movably arranged in a closed loop to cyclically pass through the at least one magnetic assembly, and a fluid supply device in fluid communication with the at least one magnetic assembly to supply a cooling fluid. The at least one magnetic regenerator includes a magnetocaloric material. In some embodiments, the at least one magnetic regenerator is arranged on a conveyor that passes through the at least one magnetic assembly and forms the closed loop. The at least one magnetic assembly may include a pair of N pole and S pole magnets or a coil.

As used herein, the term “magnetocaloric material” refers to materials that exhibit magnetocaloric effect. In general, the magnetocaloric effect refers to a process of entropic change upon application or withdrawal of an external magnetic field. On application or increase of an external magnetic field, the magnetic moments of a magnetocaloric material become more ordered and cause the magnetocaloric material to generate heat. Conversely, withdrawing or decreasing the external magnetic field allows the magnetic moments of the magnetocaloric material to become more disordered and cause the material to absorb heat. Some magnetocaloric materials exhibit the opposite behavior i.e. generating heat when the magnetic field is removed (which are sometimes referred to as para-magneto caloric materials but both types are referred to collectively herein as magneto caloric materials). The theoretical Carnot cycle efficiency of a refrigeration cycle based on an magnetocaloric material can be significantly higher than for a comparable refrigeration cycle based on a fluid refrigerant. Generally, magnetocaloric materials have pores having high permeability for flow of the heat transfer fluid, and have high capacity to absorb and dissipate heat. Suitable examples of the magnetocaloric materials include, but are not limited to, gadolinium (Gd), manganese iron compound (MnFe), lanthanum iron compounds (LaFe), or a combination thereof.

Examples of the cooling fluids include, but are not limited to, water, alcohols, antifreezes such as ethylene glycol, helium gas, or a combination thereof.

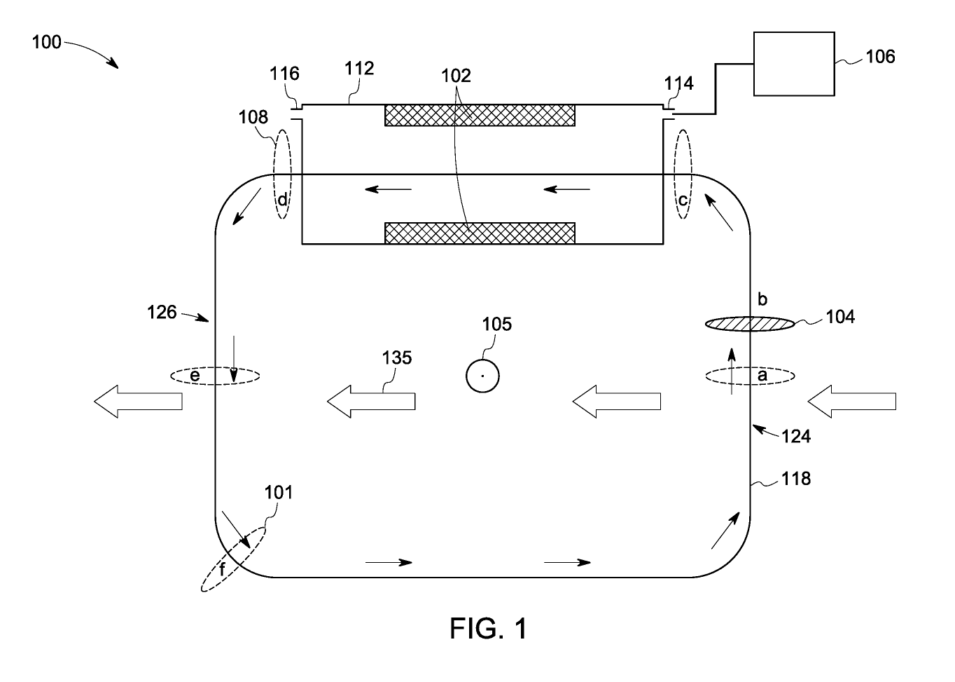

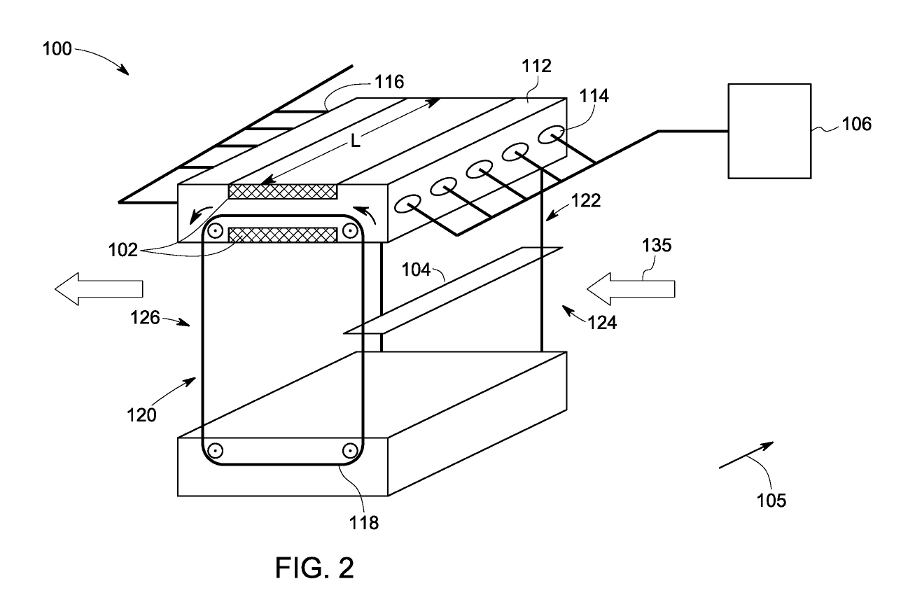

FIGS. 1 and 2 show a block diagram and a perspective view of a magnetic cooling system 100, in some embodiments. The magnetic cooling system 100 includes a magnetic assembly 102, a magnetic regenerator 104 and a fluid supply device 106 in fluid communication with the magnetic assembly 102. The magnetic cooling system 100 may have a tubular shape having a length “L” (FIG. 2) along an axis 105. The magnetic cooling system 100 may have a cross-section of any shape such as a circle, square, rectangle or oval.

As illustrated, the magnetic assembly 102 is disposed at a portion 108 of the magnetic cooling system 100. In some embodiments, the magnetic assembly 102 is disposed in a casing 112. The casing 112 may have an inlet port 114 allowing the magnetic assembly 102 to be in fluid communication with the fluid supply device 106 and an outlet port 116 allowing the magnetic assembly 102 to be in fluid communication with an outside environment. In some embodiments, the fluid supply device 106 is configured to supply a cooling fluid to the magnetic assembly 102. During operation, the cooling fluid enters to the casing 112 through the inlet port 114, flows through the magnetic assembly 102 and exits from the outlet port 116. In some embodiments, the casing 112 may have a plurality of inlet ports 114 and a plurality of outlet ports 116, as shown in FIG. 2.

The magnetic regenerator 104 is movably arranged in a closed loop 101 to cyclically pass through the magnetic assembly 102. In some embodiments, as illustrated in FIGS. 1 and 2, the magnetic regenerator 104 is arranged on a conveyor 118 that is configured to move in the closed loop 101 and passes through the magnetic assembly 102. The conveyor 118 may be a belt, chain, or rope made of metal, plastic or rubber, for example. The conveyor 118 may be arranged at any place along the length L of magnetic cooling system 100. As illustrated in FIG. 2, the conveyor 118 is arranged/located at opposing ends 120, 122 of the magnetic cooling system 100 with the magnetic regenerator 104 being held therebetween.

The magnetic regenerator 104 may be in form of a plate, a sheet, a foil, a strip or a combination thereof having a length. In some embodiments, as illustrated in FIG. 2, the magnetic regenerator 104 is in form of a thin strip (for example, about 1-5 millimeters thick) including the magnetocaloric material, that extends along the length L of the magnetic assembly 102. The dimensions of the thin strips (for example, width and thickness) may be suitable to desirably limit a resistance and pressure differential on a fluid (to be cooled) that flows across the closed loop and the magnetic cooling system 100. In addition, the thin strip may provide high surface area to maximize heat transfer between the fluid and the magnetic regenerator 104.

The magnetic regenerator 104 is arranged on the conveyor 118. The conveyor 118 may be arranged at any location along the length L of the magnetic regenerator 104. The magnetic regenerator 104 may be mechanically coupled to the conveyor 118. As illustrated in FIG. 2, the magnetic regenerator 104 is arranged on the conveyor 118 such that one end of the magnetic regenerator 104 is coupled to the conveyor 118. In some embodiments, the magnetic cooling system 100 may include an additional conveyor (not shown in figures) at other end 122 of the magnetic cooling system 100 to support the magnetic regenerator 104 along the length L.

Further, the magnetic cooling system 100 is configured to allow a fluid that has to be cooled (the fluid may also be referred to as ‘to-be cooled fluid’) to flow across the closed loop 101 through an inlet and an outlet. In some embodiments, as illustrated in FIGS. 1 and 2, the inlet and the outlet are the two sides of the magnetic cooling system 100 opposing to each other i.e., an inlet side 124 and an outlet side 126. The inlet side 124 and the outlet side 126 provide a path for the to-be cooled fluid to flow across the closed loop 101 in a direction 135 as shown by an arrow in FIGS. 1 and 2. The inlet side 124 and the outlet side 126 allow the to-be cooled fluid to enter and exit the magnetic cooling system 100 across the closed loop 101. In some other embodiments, a housing (not shown in figures) may surround the closed loop 101 and the magnetic assembly 102. The housing may have an inlet opening and an outlet opening on the inlet side 124 and the outlet side 126, respectively, to provide a path for the to-be-cooled fluid in the direction 135 through the housing. During operation, the to-be cooled fluid may come in contact to the magnetic regenerator 104 that is arranged to move in the closed loop 101, while flowing from the inlet side 124 to the outlet side 126. In some embodiments, a blower (not shown in figures) can be disposed at the inlet side 124 to direct the to-be cooled fluid through the magnetic cooling system 100.

In the magnetic cooling system 100, during operation, the magnetic regenerator 104 moves cyclically in the closed loop 101 to alternately enter and leave the magnetic field generated by the magnetic assembly 102. While in the magnetic assembly 102, the magnetic regenerator 104 becomes cooler. When the to-be cooled fluid flows through the magnetic cooling system 100 across the closed loop 101, heat transfer occurs between the to-be-cooled fluid and the magnetic regenerator 104. One complete cycle of the closed loop 101 performed by the magnetic regenerator 104 may be referred to as a cooling cycle. The process of heat transfer in one cooling cycle, in some embodiments, is described below.

Referring to FIG. 1, a to-be-cooled fluid enters through the inlet side 124 to the magnetic cooling system 100. The to-be cooled fluid has a temperature higher than the curie temperature (Tcurie) of the magnetocaloric material of the magnetic regenerator 104. At a point ‘a’ in the closed loop 101, the magnetic regenerator 104 is at a temperature (Tₐ) less than the temperature of the to-be cooled fluid. As the to-be cooled fluid comes in contact with the magnetic regenerator 104 at point ‘a’, the heat transfer occurs and the magnetic regenerator 104 takes heat from the to-be cooled fluid. The temperature of the magnetic regenerator 104 increases and the temperature of the to-be cooled fluid decreases. At point ‘b’, the temperature (T_{b}) of magnetic regenerator is higher than Tₐ and less than Tcurie (i.e., T_{b}<Tcurie). As the magnetic regenerator 104 moves towards the magnetic assembly 102 (towards point ‘c’), the magnetic regenerator 104 becomes hotter due to magnetization as it enters the magnetic field generated by the magnetic assembly 102. The temperature of the magnetic regenerator 104 increases and is higher than the Tcurie (Tc>>Tcurie) at point ‘c’. As the magnetic regenerator 104 moves through the magnetic assembly 102, a cooling fluid supplied by the fluid supply device 106 to the magnetic assembly 102, takes heat from the magnetic regenerator 104. The cooling fluid helps to control and reduce the temperature of the magnetic regenerator 104 inside the casing 112 in the magnetic field generated by the magnetic assembly 102. As the magnetic regenerator 104 leaves the magnetic field, the temperature of the magnetic regenerator 104 drops below Tcurie at point ‘d’ (T_{d}<Tcurie). The cooled magnetic regenerator 104 comes in contact with the to-be-cooled fluid) again at location “e” as the fluid exits from the outlet side 126. The heat transfer occurs, and the magnetic regenerator 104 takes heat from the to-be cooled fluid flowing in the direction 135. Due to the heat transfer, the to-be cooled fluid exiting the magnetic cooling system 100 has lower temperature as compared to the temperature of the to-be cooled fluid before contacting the magnetic regenerator 104 (or after contacting the magnetic regenerator first time near the opening at the inlet side 124). The temperature of the magnetic regenerator 104 increases after the interaction of the magnetic regenerator 104 and the to-be cooled fluid at point e′. The temperature of the magnetic regenerator at a point ‘f’ is higher than the temperature at point ‘d.’ and less than the curie temperature T_{d}<T_{f}<Tcurie. The magnetic regenerator 104 moves in the closed loop 101, and reaches the point ‘a’ to complete one cooling cycle. As the magnetic regenerator moves from point ‘f’ to ‘a’, the temperature of the magnetic regenerator 104 is less the temperature of the to-be cooled fluid entering the magnetic cooling system 100. In some embodiments, the magnetic regenerator 104 repeats this cooling cycle multiple times to continue reducing the temperature of the to-be cooled fluid supplied to the magnetic cooling system 100 and providing a cooled fluid for continuous cooling.

In some embodiments, a magnetic cooling system may include a plurality of magnetic assemblies, a plurality of magnetic regenerators or a combination thereof. The level of cooling may depend on the number of cooling cycles encountered by a fluid to be cooled (i.e., to-be cooled fluid), the number of magnetic assemblies, the number of magnetic regenerators, and their combinations arranged in a closed loop of a magnetic cooling system as described above. The number of cooling cycles may further depend, in part, on the number of magnetic regenerators arranged to move in the closed loop, the speed of a conveyor and/or the speed of the to-be-cooled fluid flow. The number of magnetic assemblies, the number of magnetic regenerators or both and the movement of the magnetic regenerators may depend on the desired temperature for the end use application. As an example, for cooling a to-be cooled fluid to a temperature in a range from 15 degrees Celsius to about 22 degrees Celsius such as for home or office cooling, the magnetic cooling system may include one magnetic assembly and a few magnetic regenerators depending on the magnetocaloric material(s) used. In another example, cooling to a much lower temperature for example, lower than 10 degrees Celsius, a plurality of magnetic regenerators and a plurality of magnetic assemblies may be required.

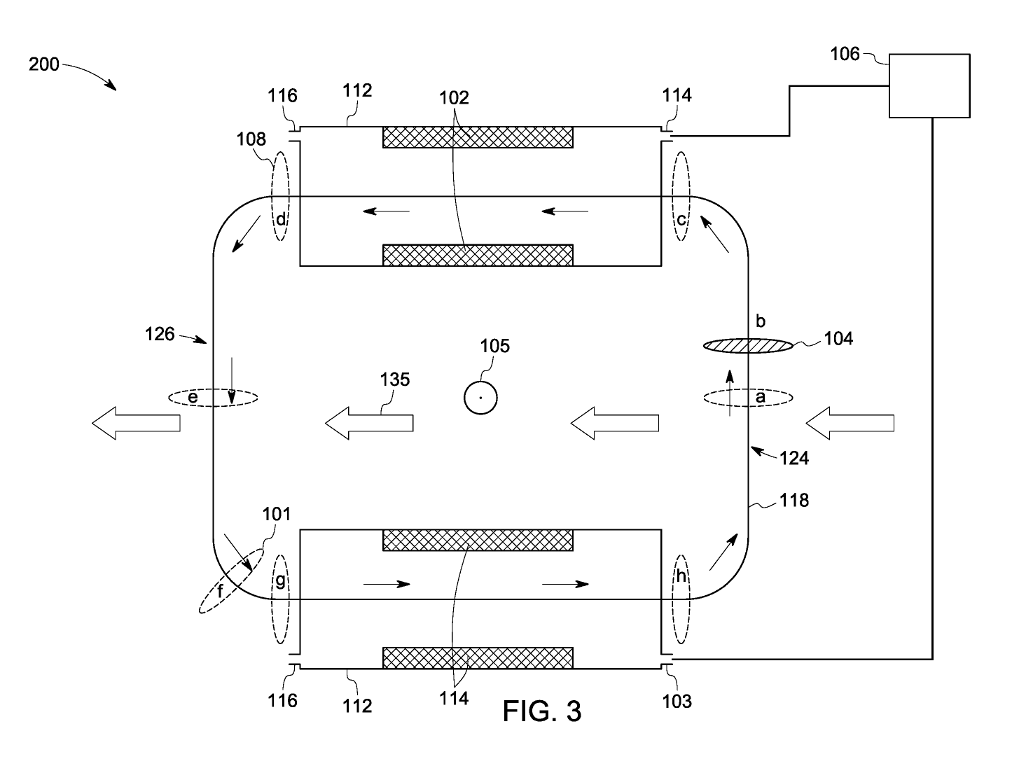

In embodiments where a magnetic cooling system includes a plurality of magnetic assemblies, a plurality of magnetic regenerators or a combination thereof, the plurality of magnetic assemblies may be disposed substantially apart. FIG. 3 illustrates a block diagram of a magnetic cooling system 200 that includes a pair of magnetic assemblies: a first magnetic assembly 102 and a second magnetic assembly 103 disposed substantially opposite to each other in the closed loop 101. The first and second magnetic assemblies (102, 103) are individually disposed in separate casings 112. In these embodiments, the fluid supply device 106 is configured to supply the cooling fluid to the first magnetic assembly 102 and the second magnetic assembly 103 during operation. In some embodiments, an additional fluid supply device may be used for supplying the cooling fluid to the second magnetic assembly 103. The magnetic regenerator 104 is movably arranged in the closed loop 101 to cyclically pass through both the first magnetic assembly 102 and the second magnetic assembly 103.

In the magnetic cooling system 200 of FIG. 3, as the magnetic regenerator 104 moves towards the second magnetic assembly 103 after crossing the point ‘e’ (i.e., from e to g), the magnetic regenerator 104 becomes hotter due to magnetization as it enters the magnetic field generated by the second magnetic assembly 103. As the magnetic regenerator 104 passes through the second magnetic assembly 103, the heat is transferred to the cooling fluid supplied by the fluid supply device (for example, 106) to the second magnetic assembly 103. As the magnetic regenerator 104 leaves the magnetic field, the temperature of the magnetic regenerator 104 drops below Tcurie at point “h” (Tₕ<Tcurie). The temperature Tₕ is lower than the temperature of the to-be cooled fluid that enters the magnetic cooling system 200 at point ‘a’. The cooled magnetic regenerator 104 comes in contact with the to-be cooled fluid again at location “a” near the inlet side 124, and completes one cooling cycle. The heat transfer occurs, and the magnetic regenerator 104 takes heat from the to-be cooled fluid flowing in the direction 135. The magnetic regenerator 104 becomes hotter i.e., the temperature of the magnetic regenerator 104 at point ‘b’ is again higher than that of point ‘a’ (T_{b}>Tₐ). In some embodiments, the magnetic regenerator 104 moves in the closed loop 101 multiple time to carry out multiple cooling cycle to cool the to-be cooled fluid that is continuously supplied to the magnetic cooling system 200.

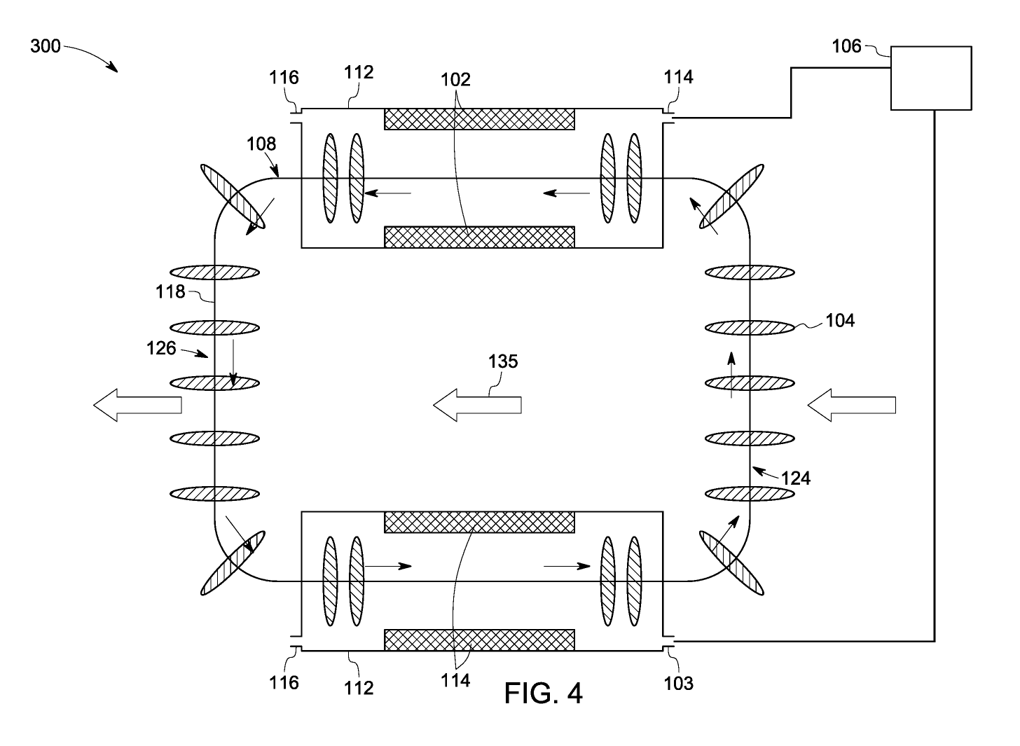

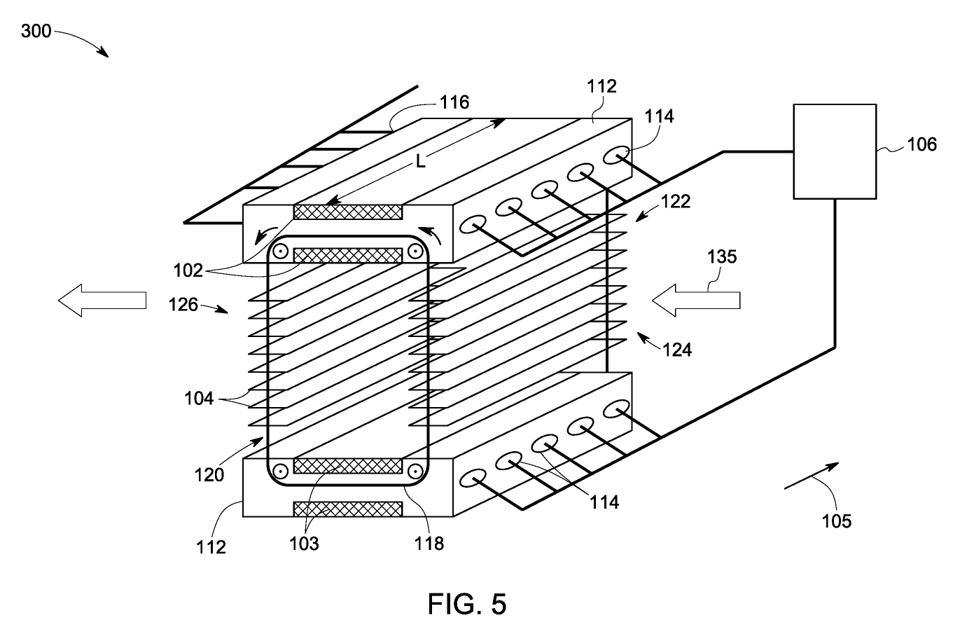

FIG. 4 illustrates a block diagram of a magnetic cooling system 300 including a pair of magnetic assemblies (102, 103) and a plurality of magnetic regenerators 104. FIG. 5 shows a schematic of the magnetic cooling system 300. Each magnetic regenerator of the plurality of magnetic regenerators 104 is moveably arranged on the conveyor 118. The magnetic regenerators of the plurality of magnetic regenerators 104 are arranged separately from each other with gaps between adjacent magnetic regenerators. Each magnetic regenerator 104 takes heat from the to-be cooled fluid as it comes in contact with while moving successively in the closed loop 101. The continuous and successive interaction of the plurality of magnetic regenerators 104 with the to-be cooled fluid flowing in the direction 135, enables continuous heat transfer from the to-be cooled fluid to the plurality of magnetic regenerators 104.

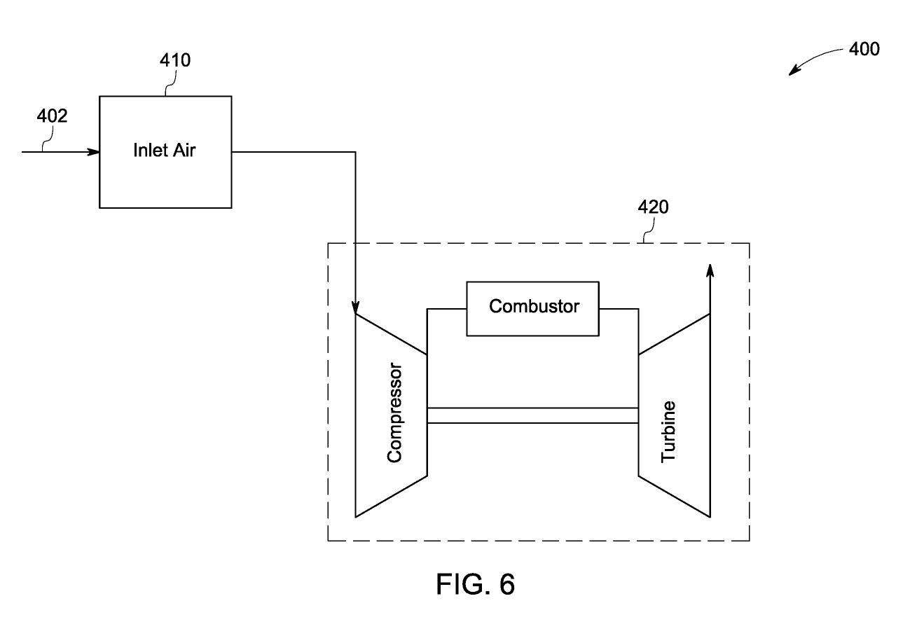

One embodiment is directed to a turbine assembly that includes a magnetic cooling system (as described hereinabove) for cooling inlet air provided to a turbine system for example, a gas turbine system. The turbine assembly includes the magnetic cooling system disposed in a path of an inlet air to the turbine system. FIG. 6 illustrates a turbine assembly 400 that includes a magnetic cooling system 410 disposed at an inlet 402 that supplies an inlet air to a turbine system 420. The inlet air is supplied to an inlet of the magnetic cooling system 410 (similar to the inlet side 124 of the magnetic cooling system 300 as shown in FIGS. 4 and 5) to flow across the closed loop 101 and exit from an outlet of the magnetic cooling system 410 (similar to the outlet side 126 of the magnetic cooling system 300 as shown in FIGS. 4 and 5). The magnetic cooling system 410 may include a plurality of magnetic assemblies and a plurality of magnetic regenerators similar to as described in embodiments shown in FIGS. 4 and 5. As illustrated, the magnetic cooling system 410 reduces the temperature of the inlet air prior to entering to the turbine system 420 to provide the cooled inlet air to the turbine system 420. In some embodiments, the temperature of the cooled inlet air is in a range from about 5 degrees Celsius to about 15 degrees Celsius.

The magnetic cooling systems, as disclosed in above embodiments, are advantageously capable of reducing the temperature to a desirable level with some alterations in the configuration. The configuration of the magnetic cooling systems may be tailored by varying the number and size of magnetic regenerators and magnetic assemblies to achieve a desired level of cooling. These magnetic cooling systems are suitable for use in the gas turbine systems for cooling the inlet air (for example, to a temperature up to 5 degrees Celsius) and providing high performance. In a gas turbine system, these magnetic cooling systems provide many advantages over conventional refrigeration or cooling techniques. Unlike, the conventional vapor compression refrigeration, the magnetic cooling system uses no refrigerants that may have environmental concerns and no compressor that may cause large parasitic losses. Further, unlike evaporation cooling techniques, the lowest temperature provided is not limited. In addition, the magnetic cooling systems are compact and have smaller footprint as compared to conventional refrigeration techniques. Their designs also provide cheaper and simpler integration with a gas turbine systems.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

1. A magnetic cooling system, comprising:
at least one magnetic assembly;
at least one magnetic regenerator comprising a magnetocaloric material, movably arranged in a closed loop to cyclically pass through the at least one magnetic assembly; and
a fluid supply device in fluid communication with the at least one magnetic assembly to supply a cooling fluid to the at least one magnetic assembly.

2. The magnetic cooling system of claim 1, wherein the at least one magnetic assembly is disposed in a casing having an inlet port allowing the magnetic assembly in fluid communication with the fluid supply device and an outlet port allowing the magnetic assembly in fluid communication with an outside environment of the casing.

3. The magnetic cooling system of claim 1, wherein the at least one magnetic regenerator comprises a plate, a sheet, a strip, a foil, or a combination thereof.

4. The magnetic cooling system of claim 1, wherein the at least one magnetic regenerator is arranged on a conveyor that passes through the at least one magnetic assembly and forms the closed loop.

5. The magnetic cooling system of claim 1, further comprising an inlet and an outlet allowing a to-be-cooled fluid to pass across the closed loop.

6. The magnetic cooling system of claim 1, wherein the magnetic cooling system comprises a plurality of magnetic regenerators movably arranged in the closed loop to cyclically pass through the at least one magnetic assembly.

7. The magnetic cooling system of claim 1, wherein the magnetic cooling system comprises a plurality of magnetic assemblies.

8. A turbine assembly comprising a magnetic cooling system disposed in a path of an inlet air to a turbine system, wherein the magnetic cooling system comprises:
a plurality of magnetic assemblies disposed substantially apart;
a plurality of magnetic regenerators comprising a magnetocaloric material, movably arranged in a closed loop to cyclically pass through the plurality of the magnetic assemblies; and
a fluid supply device in fluid communication with the plurality of the magnetic assemblies to supply a cooling fluid to the plurality of the magnetic assemblies.

9. The turbine assembly of claim 8, wherein the plurality of magnetic assemblies comprises a first magnetic assembly and a second magnetic assembly disposed substantially opposite to each other in the closed loop.

10. The turbine assembly of claim 8, wherein the plurality of magnetic regenerators comprise plates, sheets, strips, foils, or a combination thereof.

11. The turbine assembly of claim 8, wherein the plurality of magnetic regenerators are arranged on a conveyor that passes through the plurality of magnetic assemblies and forms the closed loop.

12. The turbine assembly of claim 8, wherein the magnetic cooling system further comprises an inlet and an outlet allowing the inlet air to pass across the closed loop.
